(19) United States
(12) Patent Application Publication
(10) Pub. No.: US 2008/0137632 A1
(43) Pub. Date: Jun. 12, 2008

(54) APPARATUS AND METHOD OF CONTROLLING POWER OF TERMINAL IN MOBILE COMMUNICATION SYSTEM

(75) Inventors: Yong-Seouk CHOI, Daejeon (KR); Kyung-Soo KIM, Daejeon (KR)

Correspondence Address: Jefferson IP Law, LLP, 1730 M Street, NW, Suite 807, Washington, DC, 20036, US

(73) Assignees: Electronics and Telecommunications Research Institute, Daejeon (KR); SAMSUNG ELECTRONICS CO., LTD., Suwon-city (KR)

(21) Appl. No.: 11/927,643

(22) Filed: Oct. 29, 2007

(30) Foreign Application Priority Data
Dec. 6, 2006 (KR) 10-2006-0123012

(51) Int. Cl. G08C 17/00; H04B 7/216

(52) U.S. Cl. 370/342; 370/311; 455/522

(57) ABSTRACT

The present invention relates to an apparatus and method of controlling power of a terminal in a mobile communication system. According to an exemplary embodiment of the present invention, a code division multiple access (CDMA) code is transmitted to a base station to perform an initial ranging process. Then, when a response signal to the transmitted CDMA code is not received from the base station, the initial ranging process is attempted again a predetermined number of times that is set beforehand. When the initial ranging process that is performed the predetermined number of times fails, a status of the terminal is switched to a sleep mode in which the terminal is completely turned off. Then, when the sleep mode ends, only a predetermined functional unit of the terminal that can measure the propagation environment between the terminal and the base station is turned on to measure the propagation environment. According to a result of the measurement, the status of the terminal is switched to the sleep mode again or the initial ranging process is performed again. As described above, the sleep mode and the predetermined number that is set beforehand by which the initial ranging process is performed lead to a remarkable reduction in the power consumed by the terminal.

### CROSS-REFERENCE TO RELATED APPLICATION

This application claims priority to and the benefit of Korean Patent Application No. 10-2006-0123012 filed in the Korean Intellectual Property Office on Dec. 6, 2006, the entire content of which is incorporated herein by reference.

### BACKGROUND OF THE INVENTION

(a) Field of the Invention

The present invention relates to a mobile communication system, and more particularly, to an apparatus and method of controlling power of a terminal in a mobile communication system.

(b) Description of the Related Art

A high-speed portable Internet, which is one of the mobile communication systems, has recently received a lot of attention as one of the next-generation wireless services that provide an ideal environment for wired/wireless integration. Since the high-speed portable Internet allows large capacity data to be used at a high transmission speed, this differentiates the high-speed portable Internet from wireless Internet of a mobile communication system.

Further, since the high-speed portable Internet allows terminal users to access the Internet while moving, the high-speed portable Internet complements a wireless LAN and overcomes drawbacks of the existing wireless data services. For these reasons, the high-speed portable Internet is greatly anticipated.

Because of the above-described features, terminal users are using a data service (for example streaming video, FTP, mail, chatting, and the like) instead of using a voice communication service, which was widely used by the terminal users, among various kinds of services that are provided by the high-speed portable Internet.

Such a change leads to an increase in power consumption of the terminal. That is, as compared with the voice communication service, the data service increases the time when the terminal is used due to a characteristic of the data service, which causes the power consumption of the terminal to be increased.

Recently, an initial ranging process of the terminal has become a more serious problem rather than the problem of the increase in power consumption due to the increase of time when the terminal is used.

During the initial ranging process, time synchronization between each of the terminals and a base station is performed, delay generated due to a distance difference between each of the terminals and the base station is adjusted, and radio frequency (hereinafter referred to as “RF”) output from the terminal is controlled. After the initial ranging process is successfully completed, communication between the terminal and the base station starts.

However, when the initial ranging process fails, the terminal constantly makes an attempt to perform the initial ranging process. At this time, the terminal gradually increases transmitting power and transmits an initialization signal to the base station. That is, when the terminal transmits an initialization code, the terminal increases RF output to more than that when the initial ranging process was previously performed, and transmits the initialization code to the base station. The terminal repeats a predetermined number of attempts until the initial ranging process succeeds.

Furthermore, even though the terminal repeats the predetermined number of attempts, if the initial ranging process is not successfully performed, the terminal performs a back-off process and attempts the initial ranging process again after a predetermined amount of time. At this time, when the base station cannot receive the signal transmitted by the terminal or the terminal cannot receive a signal transmitted by the base station due to a poor propagation environment between the terminal and the base station, the terminal performs another attempt to the initializing ranging process. Therefore, the power consumption of the terminal is dramatically increased.

According to associated technology, an operation mode of a terminal is subdivided such that it is possible to effectively reduce power consumption of the terminal.

However, the above technology relates to a method of reducing power consumption temporarily when there is no traffic while a link between the terminal and the base station is maintained. Therefore, there is a need for a method of efficiently controlling the amount of power consumed when the initial ranging process of the terminal is performed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and method of controlling power of a terminal in a mobile communication system that controls power consumption by switching a status of the terminal to a sleep mode when an initial ranging process between the terminal and a base station fails.

An exemplary embodiment of the present invention provides an apparatus for controlling power of a terminal in a mobile communication system. The apparatus includes a modulation/demodulation unit that demodulates a signal received from a base station and measures a propagation environment between the base station and the terminal on the basis of the demodulated signal, and a central control unit that transmits a code division multiple access (CDMA) code to the base station and makes an attempt to perform an initial ranging process, switches a status of the terminal to a sleep mode that can save power consumed by the terminal, when the attempted initial ranging process fails, and makes an attempt to perform the initial ranging process again according to a result of the measurement by the modulation/demodulation unit during the sleep mode.

Another exemplary embodiment of the present invention provides a method of controlling power of a terminal in a mobile communication system. The method includes transmitting a code division multiple access (CDMA) code to a base station and making an attempt to perform an initial ranging process, determining that the initial ranging process fails when a response signal to the transmitted code is not transmitted from the base station, switching a status of the terminal to a sleep mode that saves power consumed by the terminal according to a result of the determination, and measuring a propagation environment between the terminal and the base station after the sleep mode ends and performing the initial ranging process again when the propagation environment measurement exceeds a predetermined reference value.

### BRIEF DESCRIPTION OF THE DRAWINGS

FIG. 1 is a diagram illustrating the structure of a high-speed portable Internet system according to an exemplary embodiment of the present invention.

FIG. 2 is a diagram specifically illustrating the configuration of the apparatus for controlling power of a terminal shown in FIG. 1.

FIG. 3 is a flowchart sequentially illustrating the operation of the apparatus for controlling power of a terminal shown in FIG. 2.

FIG. 4 is a diagram conceptually illustrating time for which the terminal shown in FIG. 3 maintains a sleep mode.

### DETAILED DESCRIPTION OF THE EMBODIMENTS

In the following detailed description, only certain exemplary embodiments of the present invention have been shown and described, simply by way of illustration. However, the present invention is not limited to the following exemplary embodiments, but various modifications and changes of the invention can be made. Accordingly, the drawings and description are to be regarded as illustrative in nature and not restrictive. Like reference numerals designate like elements throughout the specification.

Hereinafter, an apparatus for controlling power of a terminal in a high-speed portable Internet system, which is one of mobile communication systems, according to an exemplary embodiment of the present invention will be described. However, the high-speed portable Internet system is but one example of the exemplary embodiment of the present invention, and the exemplary embodiment of the present invention can be applied to another communication system.

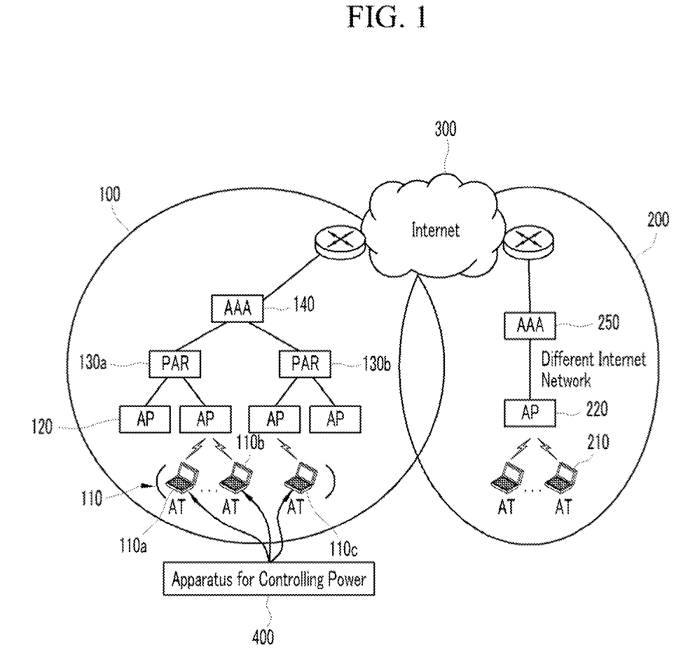

First, the high-speed portable Internet system to which the exemplary embodiment of the present invention is applied will be described in detail with reference to FIG. 1.

FIG. 1 is a diagram illustrating the structure of an IEEE 802.16e-based high-speed portable Internet system to which an exemplary embodiment of the present invention is applied.

As shown in FIG. 1, an IEEE 802.16e-based high-speed portable Internet system 100 includes access terminals 110a, 110b, and 110c, (hereinafter simply referred to as “terminal 110”), a base station (access point) 120, packet access routers (hereinafter referred to as “PAR”) 130a and 130b, and an AAA (authentication, authorization, and accounting) server 140. Further, the terminal 110 according to the exemplary embodiment of the present invention includes an apparatus for controlling power (hereinafter referred to as a “power controlling apparatus”) 400.

As such, the power controlling apparatus 400 according to the exemplary embodiment of the present invention is included in the terminal 110. However, the present invention is not limited thereto. The power controlling apparatus 400 may be included in a different constituent element that constitutes a high-speed portable Internet network.

Specifically, the terminal 110 is a subscriber station that a subscriber subscribes to so as to be provided with a portable Internet service. The terminal 110 has mobility, accesses the base station 120, and performs a radio channel transmitting/receiving function having a band frequency of 2.3 GHz according to the wireless access specification in order to transmit and receive high-speed packet data.

According to the exemplary embodiment of the present invention, the power controlling apparatus 400 included in the terminal 110 controls the amount of power consumed by the terminal 110 when an initial ranging process is performed between the terminal 110 and the base station 120. This will be described below with reference to the accompanying drawings.

The base station 120 is an apparatus that connects a wireless network and a wired network to each other. The base station 120 provides a wireless packet data service to the terminal 110 from an endpoint of the wired network by using a wireless interface. That is, the base station 120 receives a wireless signal from the terminal 110 and transmits the wireless signal to the PARs 130a and 130b, or the base station 120 transforms various pieces of information received from the PARs 130a and 130b into wireless signals and transmits the wireless signals to the terminal 110.

Each of the PARs 130a and 130b is connected to a plurality of base stations 120 by IP (Internet Protocol)-based wired communication, controls the terminal 110 and the base stations 120, and routes IP packets. At this time, communication is performed between the base stations 120 and each of the PARs 130a and 130b by using a protocol that is standardized by IEEE 802.16. When a user who subscribes to the high-speed portable Internet network starts the service, each of the PARs 130a and 130b generates a service flow and transmits information on the service flow to the base station 120. In such a manner, the user is provided with the service.

The AAA server 140 is a constituent element of the network that performs authentication, verification of authorization, and charging with respect to the user and the terminal 110 so that only a rightful user can access the high-speed portable Internet network and be provided with the service. Further, the AAA server 140 uses a Diameter protocol that is being standardized by the Internet Engineer Task Force (IETF), which is an international standardization organization. The Diameter protocol enables information on the authentication, verification of authorization, and charging to be transmitted by interworking between the servers.

The high-speed portable Internet system 100 can interwork with a different Internet network 200, which includes a terminal 210, a base station 220, and an AAA server 250, a cellular network, or a wireless LAN network through the Internet 300. The high-speed portable Internet system 100 may include one or more PARs 130a and 130b in the same network.

Further, each of the PARs 130a and 130b may include at least one base station 120 under the influence thereof. A plurality of terminals 110 are connected to one base station 120 and receive the service from the base station 120. Even if the terminal 110 moves to a new cell from a cell, which is covered by the base station 120, the terminal 110 can still receive a service from the existing cell.

The apparatus for controlling power of the terminal in the high-speed portable Internet system that has the above-described structure will now be described.

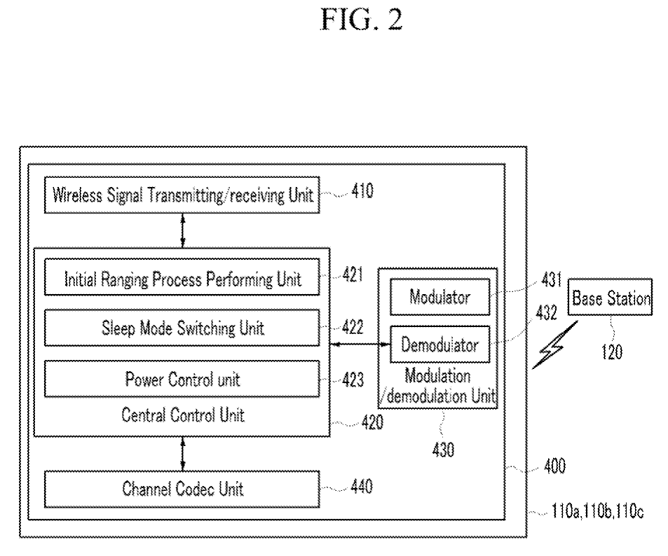

FIG. 2 is a diagram specifically illustrating an apparatus for controlling power of a terminal according to an exemplary embodiment of the present invention.

As shown in FIG. 2, the power controlling apparatus 400 of the terminal 110 according to the exemplary embodiment of the present invention includes a wireless signal transmitting/receiving unit 410, a central control unit 420, a modulation/demodulation unit 430, and a channel codec unit 440.

The central control unit 420 includes an initial ranging process performing unit 421, a sleep mode switching unit 422, and a power control unit 423. The modulation/demodulation unit 430 includes a modulator 431 and a demodulator 432.

Specifically, the wireless signal transmitting/receiving unit 410 of the power controlling apparatus 400 receives a DL/UL MAP message that is broadcast from the base station 120. Subsequently, the wireless signal transmitting/receiving unit 410 receives downlink channel descriptor/uplink channel descriptor (DCD/UCD) information that is information on channels allocated by the base station 120.

For reference, the DL/UL MAP message includes uplink and downlink channel allocation information and system information.

Then, the wireless signal transmitting/receiving unit 410 transmits a code division multiple access (CDMA) code to the base station 120 in order to perform an initial ranging process between the terminal 110 and the base station 120. Then, the wireless signal transmitting/receiving unit 410 receives an RNG-RSP message that is a response signal to the transmitted code, from the base station.

Next, the initial ranging process performing unit 421 of the central control unit 420 makes attempts to perform the initial ranging process of a predetermined number that is set in advance according to a propagation environment between the terminal 110 and the base station 120. When the initial ranging process performing unit 421 makes an attempt to perform an initial ranging process again, the initial ranging process performing unit 421 increases an output level to a predetermined level and causes the CDMA code to be transmitted to the corresponding base station.

Specifically, when the initial ranging process performing unit 421 receives the DL/UL MAP message and the CD/UCD information normally from the base station 120, the initial ranging process performing unit 421 allows the CDMA code to be transmitted to the base station 120 according to a first output that has a predetermined output level.

However, when the response signal to the CDMA code is not received from the base station 120 or the CDMA code is not transmitted to the corresponding base station 120 due to the poor propagation environment between the terminal 110 and the base station 120, the initial ranging process performing unit 421 makes an attempt to perform the initial ranging process between the base station and the terminal again.

At this time, the initial ranging process performing unit 421 makes attempts of the predetermined number that is set beforehand to perform the initial ranging process according to the exemplary embodiment of the present invention. In the exemplary embodiment of the present invention, the predetermined number is limited to three. That is, the predetermined number is limited to three, including the initial ranging process that is performed first. However, the present invention is not limited thereto. The predetermined number may be less or more than three according to the case.

That is, when the first initial ranging process fails, the initial ranging process performing unit 421 re-transmits the CDMA code to the base station 120 according to a second output. At this time, the second output is higher than the first output by a predetermined level. The output level is gradually increased in order for the initial ranging process between the terminal and the base station to be successfully performed.

Then, when the second initial ranging process also fails, the initial ranging process performing unit 421 transmits the CDMA code to the base station 120 according to a third output. The third output has a higher output level than the second output by a predetermined level.

When the initial ranging process that is performed by the predetermined number fails, the sleep mode switching unit 422 switches a status of the terminal 110 to a sleep mode in which all of the functional units of the terminal 110 are turned off for a predetermined amount of time, that is, for a first time. This means that the sleep mode switching unit 422 waits until the propagation environment between the base station 120 and the terminal 110 is improved while saving the amount of power consumed by the terminal 110.

Further, the sleep mode switching unit 422 does not turn on all of the functional units of the terminal when the first time ends, but turns on the wireless signal transmitting/receiving unit 410 and the demodulator 431 that can measure the propagation environment between the terminal 110 and the base station 120 according to the exemplary embodiment of the present invention. This serves to reduce a waste of power that is caused when all of the functional units in the terminal are turned on.

Then, according to a result of measuring the propagation environment by the wireless signal transmitting/receiving unit 410 and the demodulator 431, when the propagation environment measurement between the terminal 110 and the base station 120 exceeds a reference value, the sleep mode switching unit 422 attempts to perform the initial ranging process again.

Then, as the result of the measurement, when the propagation environment measurement does not exceed the reference value, the sleep mode switching unit 422 switches the status of the terminal to the sleep mode in which the wireless signal transmitting/receiving unit 410 and the demodulator 431 are turned off. At this time, the sleep mode is maintained for a time that is twice as long as the first time, such that the power consumption of the terminal 110 is reduced and a success rate in performing the initial ranging process is improved.

The power control unit 423 turns at least one functional unit of the terminal 110 on or off under the control of the sleep mode switching unit 422.

The modulator 431 of the modulation/demodulation unit 430 modulates a signal by using a predetermined modulating method according to the propagation environment between the terminal 110 and the base station 120.

The demodulator 432 demodulates the signal (for example, the DL/UL MAP message) that is broadcast from the base station 120. Further, the demodulator 432 measures the current propagation state between the base station 120 and the terminal 110 with reception sensitivity of the demodulated signal. That is, the demodulator 432 measures the propagation environment between the terminal 110 and the base station 120 according to whether the message transmitted by the base station 120 is received or not.

The channel codec unit 440 performs an encoding operation according to the uplink and downlink channels, and performs an interleaving process and an error correcting process.

Now, the operation of the apparatus for controlling power that has the above-described structure will be described.

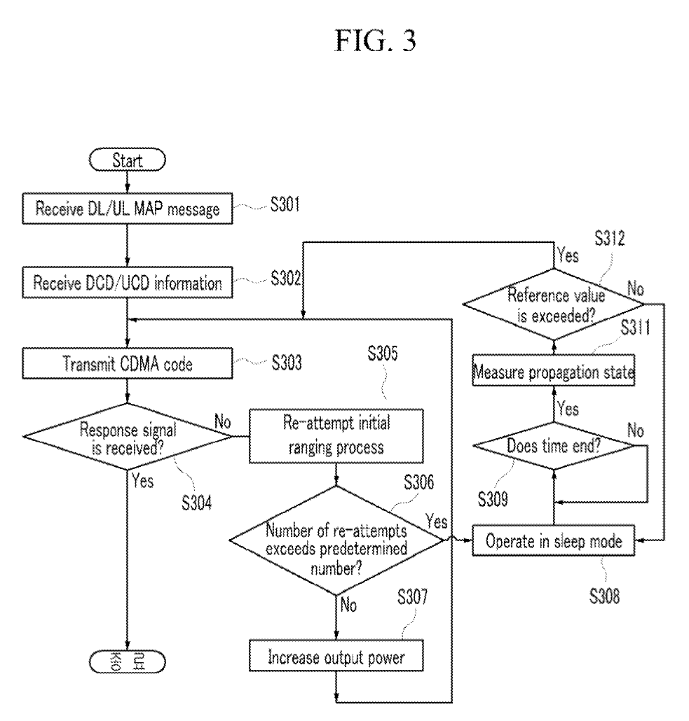

FIG. 3 is a flowchart sequentially illustrating the operation of the apparatus for controlling power of a terminal shown in FIG. 2.

As shown in FIG. 3, the wireless signal transmitting/receiving unit 410 of the power controlling apparatus 400 receives a DL/UL MAP message that is broadcast from the base station 120 (Step S301). The DL/UL MAP message includes uplink and downlink channel allocation information and system information.

Then, the wireless signal transmitting/receiving unit 410 receives DCD/UCD information, which is information on channels that are allocated by the base station 120, from the base station 120 (Step S302).

For reference, the reception processes are performed before an initial ranging process between the terminal 110 and the base station 120 is performed. The initial ranging process starts only when the two processes are normally completed.

That is, in order to perform the initial ranging process on the basis of the signal received from the base station 120, the initial ranging process performing unit 421 of the central control unit 420 transmits a CDMA code to the base station according to a first output having a predetermined output level (Step S303).

Then, the base station 120 transmits an RNG-RSP message, which is a response signal to the CDMA code received from the terminal 110, to the corresponding terminal 110. The wireless signal transmitting/receiving unit 410 of the terminal 110 normally receives the RNG-RSP message from the base station 120 (Step S304). In such a manner, the initial ranging process is successfully completed.

However, when the above-described initial ranging process is performed, the following case frequently occurs. That is, even after a predetermined amount of time passes, the base station 120 cannot receive the CDMA code transmitted by the terminal 110 or the terminal 110 cannot receive the response signal transmitted by the base station 120 due to the poor propagation environment between the terminal 110 and the base station 120.

Therefore, the initial ranging process performing unit 421 makes an attempt to perform the initial ranging process between the base station 120 and the terminal 110 again (Step S305). At this time, according to the exemplary embodiment of the present invention, the initial ranging process performing unit 421 makes an attempt to perform the initial ranging process again a predetermined number of times that is set beforehand (Step S306).

That is, the power controlling apparatus 400 of the terminal 110 according to the exemplary embodiment of the present invention limits the number of attempts to perform the initial ranging process to the predetermined number set beforehand. In such a manner, the power consumption of the terminal 110, which is caused when the initial ranging process performing unit 421 constantly makes an attempt to perform the initial ranging process again due to the failure of the initial ranging process between the terminal 110 and the base station 120, can be reduced.

Specifically, when the response signal to the first CDMA code that is transmitted to the base station 120 is not received from the base station 120 or the CDMA code is not transmitted to the corresponding base station 120, the initial ranging process performing unit 421 transmits the CDMA code again to the base station 120 according to a second output (Step S307).

At this time, the second output is higher than the first output by a predetermined level. The second CDMA code is transmitted to the base station according to the second output that is higher than the first output by the predetermined level in order to successfully perform the initial ranging process.

Then, when the second initial ranging process also fails, the initial ranging process performing unit 421 transmits the CDMA code to the base station 120 according to a third output. The third output level is higher than the second output level by a predetermined level.

Then, when the third initial ranging process also fails, the initial ranging process performing unit 421 proceeds to a next step to control the power of the terminal 110. That is, as described above, in order to prevent the wasteful power consumption of the terminal, the initial ranging process performing unit 421 performs the initial ranging process three times that corresponds to the predetermined number that is set beforehand.

As such, according to the exemplary embodiment of the present invention, the number of times of performing the initial ranging process is limited to three. However, the present invention is not limited thereto. Depending on the case, the number may be less or more than three.

Then, when exceeding the number of times of performing the initial ranging process that is set beforehand, the sleep mode switching unit 422 switches a status of the terminal 110 to a sleep mode in which all of the functional units of the terminal 110 are turned off for the first time that is the predetermined time (Step S308). At this time, the power control unit 423 of the power controlling apparatus 400 turns at least one functional unit of the terminal on or off while under the control operation of the sleep mode switching unit 422.

As such, the power controlling apparatus 400 according to the exemplary embodiment of the present invention makes an attempt to perform the initial ranging process the predetermined number of times, and immediately switches the status of the terminal 110 to the sleep mode. This means that the terminal waits until the propagation environment between the base station and the terminal is improved while saving the amount of power consumed by the terminal.

Then, when the first time ends (Step S309), the sleep mode switching unit 422 turns on the terminal 110 again.

At this time, the sleep mode switching unit 422 controls the power control unit 423 by the following method. The sleep mode switching unit 422 does not turn on all of the functional units of the terminal 110, but turns on the wireless signal transmitting/receiving unit 410 and the demodulator 431 of the modulation/demodulation unit 430 that can measure the propagation environment between the terminal 110 and the base station 120. This also prevents the wasteful power consumption caused when all of the functional units of the terminal 110 are turned on.

Then, the demodulator 431, which is turned on, of the modulation/demodulation unit 430 measures the current propagation state between the terminal and the base station with reception sensitivity of the signal that is broadcast from the base station 120 (Step S311).

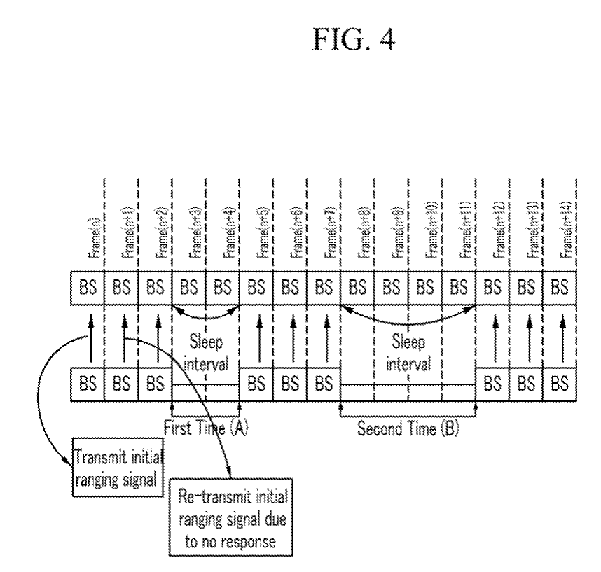

As a result of the measurement, when the propagation environment measurement between the terminal 110 and the base station 120 does not exceed a reference value (Step S312), the sleep mode switching unit 422 switches the status of the terminal 110 to the sleep mode again. First, the power control unit 423 turns off the wireless signal transmitting/receiving unit 410 and the demodulator 431. At this time, the sleep mode switching unit 422 increases the time during which the corresponding functional units are turned off, so that it is twice as long as the first time. An example of this is shown in FIG. 4.

As shown in FIG. 4, the sleep mode switching unit 422 turns off the wireless signal transmitting/receiving unit 410 and the demodulator 431 of the terminal 110 by using the power control unit 423 for a time B that is twice as long as a first time A. In such a manner, a success rate of performing the initial ranging process between the terminal and the base station can be improved. However, the present invention is not limited thereto. Depending on the case, the time during which the terminal operates in the sleep mode can be controlled.

Meanwhile, as the result of the measurement, when the propagation environment measurement between the terminal 110 and the base station 120 exceeds the predetermined reference value (Step S312), the sleep mode switching unit 422 turns on the rest of the functional units of the terminal 110 by using the power control unit 423 and causes an attempt to perform the initial ranging process with the base station 120 again (Steps S303 and S304).

At this time, as described above, the initial ranging process performing unit 421 makes an attempt to perform the initial ranging process between the terminal 110 and the base station 120 the predetermined number of times. During the re-attempt, the initial ranging process performing unit 421 constantly transmits the CDMA code to the base station according to fourth to sixth outputs, each of which has a higher output level than the third output.

As described above, the apparatus and method of controlling power of a terminal in the high-speed portable Internet system according to the exemplary embodiment of the present invention attempts an initial ranging process between the terminal and the base station a predetermined number of times. Therefore, the apparatus and method can significantly reduce the power consumption of the terminal that is caused when the attempt to perform the initial ranging process is constantly made without limit.

Further, after the initial ranging process is performed the predetermined number of times that is set beforehand, the apparatus and method switches the status of the terminal to the sleep mode in which the terminal is completely turned off. Therefore, the amount of power consumed by the terminal can be remarkably saved.

Further, the apparatus and method does not completely turn on the terminal after the sleep mode ends. Rather, the apparatus and method turns on the functional units that can measure the propagation environment between the terminal and the base station, and then allows an attempt to perform the initial ranging process to be made again according to a result of the measurement by the functional units. Therefore, the amount of power consumed by the terminal can be saved.

It should be understood that the above drawings and detailed description of the embodiments are not limitative, but are illustrative in all aspects. It can be understood by those skilled in the art that the invention is intended to cover various modifications and other equivalent arrangements. Therefore, the scope of the present invention is defined by the appended claims rather than by the description preceding them.

The apparatus and method of controlling power of a terminal in the mobile communication system according to the exemplary embodiments of the present invention makes an attempt to perform the initial ranging process between the terminal and the base station a predetermined number of times that is set beforehand, and switches the status of the terminal to the sleep mode, when the initial ranging process fails after the predetermined number of times, such that the amount of power consumed by the terminal can be significantly reduced.

Further, according to the apparatus and method of controlling power of a terminal in the mobile communication system according to the exemplary embodiments of the present invention, after the sleep mode ends, only the predetermined functional units of the terminal that can measure the propagation environment are turned on to measure the propagation environment, such that the power consumption of the terminal can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for controlling power of a terminal in a mobile communication system, the apparatus comprising:
a modulation/demodulation unit that demodulates a signal received from a base station and measures a propagation environment between the base station and the terminal on the basis of the demodulated signal; and
a central control unit that transmits a code division multiple access (CDMA) code to the base station and makes an attempt to perform an initial ranging process, switches a status of the terminal to a sleep mode that can save an amount of power consumed by the terminal when the attempted initial ranging process fails, and makes an attempt to perform the initial ranging process again according to a result of the measurement by the modulation/demodulation unit during the sleep mode.

2. The apparatus of claim 1, wherein the central control unit includes:
an initial ranging process performing unit that transmits the CDMA code to the base station;
a sleep mode switching unit that maintains the status of the terminal in the sleep mode for a predetermined amount of time when the attempted initial ranging process fails; and
a power control unit that turns at least one functional unit of the terminal on or off.

3. The apparatus of claim 2, wherein, when the sleep mode ends and a result of the measurement by the modulation/demodulation unit does not exceed a reference value, the sleep mode switching unit switches the status of the terminal to the sleep mode again, and increases the time during which the terminal is maintained in the sleep mode to at least twice as long as the previous time.

4. The apparatus of claim 2, wherein, when the sleep mode ends, the sleep mode switching unit turns on predetermined functional units of the terminal, which can measure the propagation environment between the terminal and the base station, by using the power control unit.

5. The apparatus of claim 2, wherein, when the attempted initial ranging process fails, the initial ranging process performing unit increases an output level stepwise and transmits the CDMA code to the base station.

6. The apparatus of claim 2, wherein the initial ranging process performing unit makes an attempt to perform the initial ranging process a predetermined number of times that is set beforehand.

7. The apparatus of claim 2, wherein the sleep mode switching unit determines that the initial ranging process fails when a response signal to the transmitted CDMA code is not received from the base station.

8. A method of controlling power of a terminal in a mobile communication system, the method comprising:
transmitting a code division multiple access (CDMA) code to a base station and making an attempt to perform an initial ranging process;
determining that the initial ranging process fails when a response signal to the transmitted code is not transmitted from the base station;
switching a status of the terminal to a sleep mode that saves an amount of power consumed by the terminal according to a result of the determination; and
measuring a propagation environment between the terminal and the base station after the sleep mode ends and performing the initial ranging process again when the propagation environment measurement exceeds a predetermined reference value.

9. The method of claim 8, wherein the measuring of the propagation environment and performing of the initial ranging process again include:
switching the status of the terminal to the sleep mode again when the propagation environment measurement does not exceed the reference value; and
increasing a sleep mode interval of the terminal, of which status is switched to the sleep mode again, to at least twice as long as a previous sleep mode interval and maintaining the terminal in the sleep mode.

10. The method of claim 9, wherein, in the measuring of the propagation environment and performing of the initial ranging process again, predetermined functional units of the terminal are turned on after the sleep mode of the terminal ends to measure the propagation environment between the terminal and the base station.

11. The method of claim 8, wherein the transmitting of the CDMA code to the base station and making the attempt to perform the initial ranging process includes transmitting the CDMA code to the base station a predetermined number of times and increasing an output level stepwise when transmitting the CDMA code.
